(19) United States
(12) Patent Application Publication
(10) Pub. No.: US 2022/0397711 A1
(43) Pub. Date: Dec. 15, 2022

(54) PATTERNED LYOTROPIC LC POLARIZERS

(71) Applicant: SHARP KABUSHIKI KAISHA, Sakai City (JP)

(72) Inventors: Nathan James SMITH, Oxford (GB); JIYUN YU, Didcot (GB); ANDREW ACREMAN, Oxford (GB); KIYOSHI MINOURA, Sakai City (JP); AKIRA SAKAI, Sakai City (JP); MASAHIRO HASEGAWA, Sakai City (JP); MIHO YAMADA, Sakai City (JP)

(21) Appl. No.: 17/342,964

(22) Filed: Jun. 9, 2021

(51) Int. Cl. G02B 5/30; G02F 1/1335; G02B 1/18

(52) U.S. Cl. CPC G02B 5/3016; G02F 1/133528; G02B 1/18

(57) ABSTRACT

A polarizer for use with a display device having a viewing area and a non-viewing area includes a patterned hydrophobic layer, a patterned lyotropic liquid crystal (LC) polarizer layer, a lyotropic LC polarizer alignment layer, a reactive mesogen (RM) quarter wave plate (QWP) layer, an RM QWP alignment layer, a substrate, and an adhesive. The patterned hydrophobic layer surrounds the patterned lyotropic LC polarizer layer. The patterned hydrophobic layer is wholly contained within the non-viewing area of the display device. The substrate is adjacent to the RM QWP alignment layer, and the adhesive is disposed between the substrate and the display device.

### FIELD

The present disclosure relates to fabrication techniques of thin liquid crystal (LC) polarizers for use with display devices.

### BACKGROUND

Polarizers can be classified as either linear polarizers or circular polarizers. A circular polarizer is a combination of a linear polarizer and a quarter wave plate (QWP). Linear and circular polarizers are essential optical elements for most liquid crystal displays (LCDs).

Circular polarizers are important for emissive displays such as organic light emitting displays (OLEDs) and quantum dot light emitting displays (QLEDs), among others. Circular polarizers may be used for reducing unwanted ambient reflections from internal layers of a display to improve ambient contrast ratio.

Conventional linear polarizers used for display applications include a uniaxial stretched poly(vinyl alcohol) that has been impregnated with iodine or doped with dichroic dyes. Conventional linear polarizers exhibit excellent dichroic ratios (typically >50) but are relatively thick (e.g., about 100 μm). The thickness of conventional polarizers precludes their use for in-cell LCD applications in which a polarizer is deposited between substrates that form an LC cell. The thickness of conventional polarizers is also detrimental to the mechanical performance of flexible, bendable and curved displays.

Thinner linear polarizers that use a lyotropic LC material have been proposed to address the thickness problem of conventional polarizers. Two disadvantages of lyotropic LC polarizer materials are their relatively poor mechanical robustness and relatively poor chemical robustness. Lyotropic LC polarizers are not robust to water and are easily damaged by moisture. To protect against mechanical damage and/or chemical damage, a lyotropic LC polarizer may be completely encapsulated by other materials.

The present disclosure provides manufacturing methods for a display device that includes a patterned lyotropic LC polarizer. Deposition of an overcoat layer on a patterned lyotropic LC polarizer protects the delicate polarizer material from mechanical damage and chemical damage.

### SUMMARY

A liquid crystal (LC) polarizer apparatus for use with a display device having a viewing area and a non-viewing area includes a patterned hydrophobic layer and a patterned lyotropic LC polarizer layer. The patterned hydrophobic layer surrounds the patterned lyotropic LC polarizer layer, and the patterned hydrophobic layer is wholly contained within the non-viewing area of the display device.

The patterned lyotropic LC polarizer layer may be formed from an evaporated lyotropic LC polarizer solution of water and dichroic dye, and may comprise substantially uniformly aligned dichroic dye molecules, the dichroic dye molecules spatially patterned according to a patterning of the patterned hydrophobic layer. The patterned lyotropic LC polarizer layer may have a thickness different from a thickness of the patterned hydrophobic layer.

The LC polarizer apparatus may also include a lyotropic LC polarizer alignment layer, which may be adjacent the patterned lyotropic LC polarizer layer. The lyotropic LC polarizer alignment layer may be configured to align a transmission axis of the patterned lyotropic LC polarizer layer at a first in-plane angle relative to the display device. An alignment direction of the lyotropic LC polarizer alignment layer may be configured using at least one of a rubbing process, a photoalignment process, a plasma treatment process, an ultra-violet light treatment process, and an ozone treatment process.

The LC polarizer apparatus may include a substrate adjacent the lyotropic LC polarizer alignment layer. The LC polarizer apparatus may also include a reactive mesogen (RM) quarter wave plate (QWP) layer and may have an RM QWP alignment layer adjacent the RM QWP layer. The RM QWP alignment layer may be configured to align a transmission axis of the RM QWP layer at a second in-plane angle relative to the display device. In certain instances, the second in-plane angle is 45° relative to a first in-plane angle of the patterned lyotropic LC polarizer layer. The LC polarizer apparatus may also include a substrate adjacent the RM QWP alignment layer.

The LC polarizer apparatus may include an overcoat layer, in various implementations with the overcoat layer configured to extend over the patterned lyotropic LC polarizer layer, and the patterned hydrophobic layer. At least one of the patterned hydrophobic layer and the patterned lyotropic LC polarizer layer may be configured with a modified surface energy that facilitates adhering the overcoat layer thereto.

The patterned hydrophobic layer may be a fluoropolymer material including at least one material selected from the group consisting of polytetrafluoroethylene (PTFE), polyvinylfluoride, polyvinylidene fluoride, polychlorotrifluoroethylene, perfluoroalkoxy polymer, fluorinated ethylene-propylene, polyethylenetetrafluoroethylene, polyethylenechlorotrifluoroethylene, Perfluorinated Elastomer, Fluorocarbon, Chlorotrifluoroethylenevinylidene fluoride, Fluoroelastomer, Tetrafluoroethylene-Propylene, Perfluoropolyether, polyimide, and a liquid crystal alignment layer that promotes vertical alignment of liquid crystals.

The viewing area of the LC polarizer apparatus may contain pixels of the display device, and the non-viewing area may lack pixels of the display device. In various implementations, the LC polarizer apparatus may include a liquid crystal display, wherein the LC polarizer is an in-cell polarizer.

In one alternative implementation, a polarizer apparatus for use with a display device having a viewing area and a non-viewing area may include a patterned hydrophobic layer, a patterned lyotropic liquid crystal (LC) polarizer layer, a lyotropic LC polarizer alignment layer, a reactive mesogen (RM) quarter wave plate (QWP) layer, and an RM QWP alignment layer, wherein the patterned hydrophobic layer surrounds the patterned lyotropic LC polarizer layer. In such an implementation, the patterned hydrophobic layer may be wholly contained within the non-viewing area of the display device, and the RM QWP alignment layer may be adjacent the display device.

In another alternative implementation, a polarizer for use with a display device having a viewing area and a non-viewing area may include a patterned hydrophobic layer, a patterned lyotropic liquid crystal (LC) polarizer layer, a lyotropic LC polarizer alignment layer, a reactive mesogen (RM) quarter wave plate (QWP) layer, an RM QWP alignment layer, a substrate, and an adhesive, wherein the patterned hydrophobic layer may surround the patterned lyotropic LC polarizer layer, the patterned hydrophobic layer may be wholly contained within the non-viewing area of the display device, the substrate may be adjacent to the RM QWP alignment layer, and the adhesive may be disposed between the substrate and the display device.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 illustrates a conventional circularly polarizing plate.

FIG. 2A illustrates axes and angles in a coordinate system for providing pertinent terms of orientation as discussed herein.

FIG. 2B illustrates a series of axes that are orthogonal to each other in a plane of a display device.

FIG. 3A illustrates an optical element including a substrate and either a linear polarizer or a circular polarizer.

FIG. 3B illustrates a display device including a display and a circular polarizer.

FIG. 3C illustrates an alternative display device including a substrate, an adhesive layer, and a display.

FIG. 3D illustrates a circular polarizer that may be used in conjunction with the display devices discussed herein.

FIG. 3E illustrates a linear polarizer that may be used in conjunction with the display devices discussed herein.

FIG. 4A illustrates a substrate upon which a lyotropic LC polarizer alignment layer has been deposited.

FIG. 4B illustrates a patterned hydrophobic layer that has been deposited upon the optical element shown in FIG. 4A.

FIG. 4C illustrates a lyotropic LC polarizer layer deposited on the lyotropic LC polarizer alignment layer.

FIG. 4D illustrates the deposition of an overcoat layer to protect the lyotropic LC polarizer from mechanical and/or chemical damage.

FIG. 5A illustrates an RM QWP alignment layer deposited on a substrate.

FIG. 5B illustrates a patterned hydrophobic layer deposited on the optical element shown in FIG. 5A.

FIG. 5C illustrates a lyotropic LC polarizer layer deposited onto the RM QWP alignment layer.

FIG. 5D illustrates the deposition of an overcoat layer to protect the RM QWP from mechanical and/or chemical damage.

FIG. 6A illustrates a substrate upon which a lyotropic LC polarizer alignment layer has been deposited.

FIG. 6B illustrates an unpatterned hydrophobic layer deposited upon the substrate.

FIG. 6C illustrates the resulting pattern on the hydrophobic layer.

FIG. 6D illustrates a lyotropic LC polarizer layer deposited on the patterned hydrophobic layer.

FIG. 6E illustrates the deposition of an overcoat layer to protect the patterned hydrophobic layer and lyotropic LC polarizer layer from mechanical and/or chemical damage.

FIG. 7A illustrates an RM QWP alignment layer deposited on a substrate.

FIG. 7B illustrates an unpatterned hydrophobic layer deposited upon the substrate.

FIG. 7C illustrates the resulting pattern on the hydrophobic layer.

FIG. 7D illustrates a lyotropic LC polarizer layer deposited on the patterned hydrophobic layer.

FIG. 7E illustrates the deposition of an overcoat layer to protect the patterned hydrophobic layer and lyotropic LC polarizer layer from mechanical and/or chemical damage.

FIG. 8A illustrates a flowchart describing the process illustrated in FIGS. 4B-4D and FIGS. 5B-5D.

FIG. 8B illustrates a flowchart describing the process illustrated in FIGS. 6B-6E and FIGS. 7B-7E.

FIG. 9A illustrates a plan view of a display device.

FIG. 9B illustrates an elevation view of a first implementation display device.

FIG. 9C illustrates an elevation view of a second implementation display device.

FIG. 10A illustrates part of an LC display that includes a first optical element.

FIG. 10B illustrates part of an LC display that includes a first optical element and a second optical element.

### DETAILED DESCRIPTION

The following description contains specific information pertaining to exemplary implementations of the present disclosure. The drawings in the present disclosure and their accompanying detailed description are directed to merely exemplary implementations. However, the present disclosure is not limited to merely these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features are identified (although, in some examples, not shown) by numerals in the exemplary figures. However, the features in different implementations may differ in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates an open-ended inclusion or membership in the so-described combination, group, series, and the equivalent.

Additionally, for purposes of explanation and non-limitation, specific details, such as functional entities, techniques, protocols, standards, and the like, are set forth for providing an understanding of the described technology. In other examples, detailed description of well-known methods, technologies, system architectures, and the like are omitted so as not to obscure the description with unnecessary details.

Implementations of the present disclosure will now be described with reference to the drawings in which reference numerals are used to refer to like elements throughout. It will be understood that the figures are not necessarily to scale.

The present disclosure provides manufacturing methods for a patterned lyotropic liquid crystal (LC) polarizer. The present disclosure provides manufacturing methods for a display device that includes a patterned lyotropic liquid crystal (LC) polarizer. Deposition of an overcoat layer on a patterned lyotropic LC polarizer protects the delicate polarizer material from mechanical damage and chemical damage.

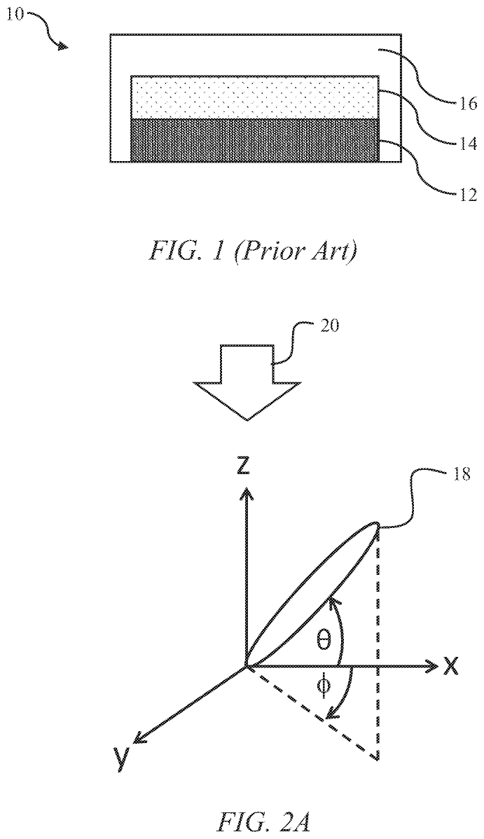

Referring to FIG. 1, a polarizer may include a circularly polarizing plate 10 comprising a quarter wave plate (λ/4) layer 12 and a polarizing layer 14 which is superposed on the λ/4 layer 12 and contains a lyotropic LC polarizer material. The circularly polarizing plate 10 has an overcoat layer 16 formed to cover upper and lateral surfaces of the polarizing layer 14 and lateral surfaces of the λ/4 layer 12. The overcoat layer 16 therefore completely encapsulates the lyotropic LC polarizer (in the polarizing layer 14), thereby preventing mechanical damage and/or chemical damage of the lyotropic LC polarizer.

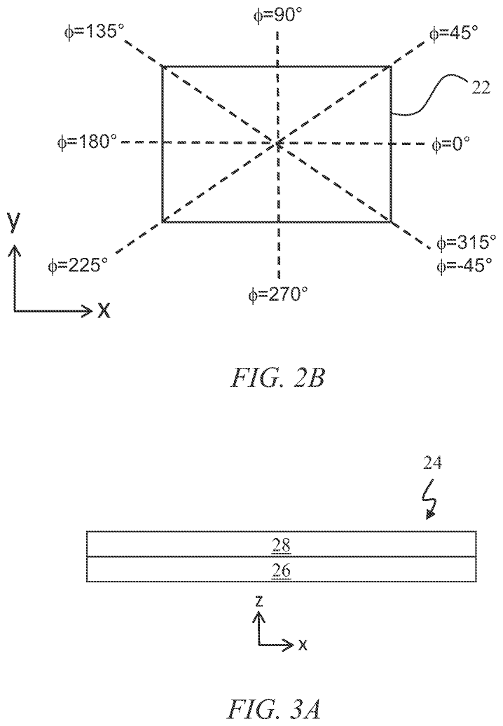

Referring to FIG. 2A, axes x, y, and z are shown, along with angles ϕ and θ in a coordinate system for providing pertinent terms of orientation in this disclosure with regard to an object 18, and a viewing side 20 of the object 18. As used herein, angle ϕ refers to the angle of the object 18 in a plane defined by axes x and y, whereas angle θ refers to the object's 18 angle relative to axis z, away from the plane defined by axes x and y.

FIG. 2b shows that the axes x and y are orthogonal to each other. The angle between the x-axis and the y-axis is defined as the in-plane (azimuthal) angle ϕ with the term “in-plane” signifying being in the plane of a display device 22. The angle between the x-axis (or y-axis) and the z-axis is the out-of-plane (zenithal) angle θ (FIG. 2A) relative to the plane of the display device 22.

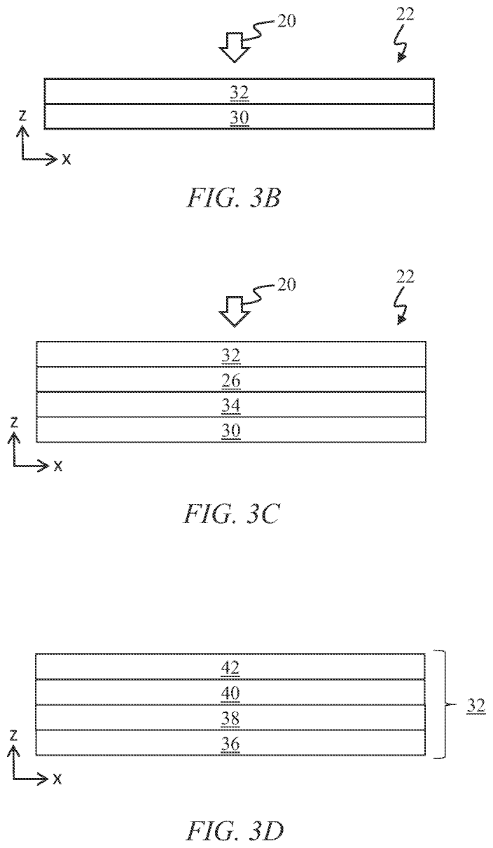

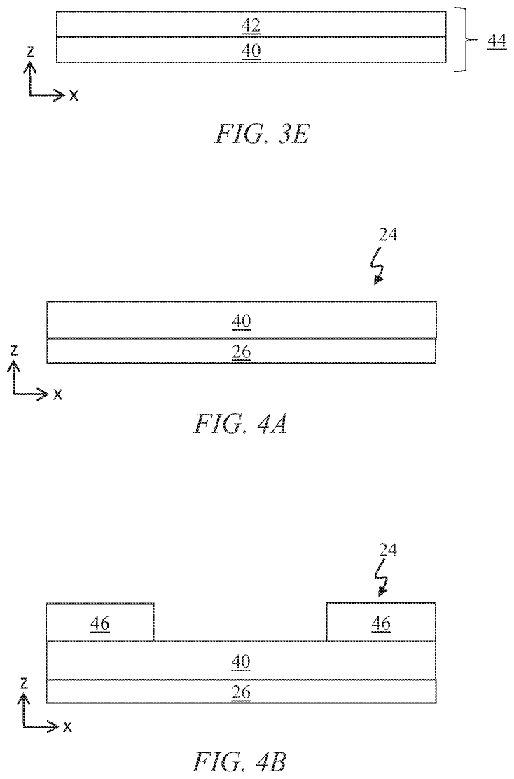

FIG. 3A shows an optical element 24 that is comprised of a substrate 26 and a polarizer 28, which may be either a linear polarizer or a circular polarizer. The polarizer 28 (e.g., linear or circular) is deposited upon the substrate 26. The substrate 26 may be optically clear. Additionally, the substrate 26 may be comprised of an inorganic material, such as glass, and/or the substrate 26 may be comprised of an organic material, such as a polymer.

FIG. 3B shows a display device 22 that is comprised of a display 30 and a circular polarizer 32. The circular polarizer 32 is disposed on the viewing side 20 of the display device 22. The display 30 shown in FIG. 3B may interchanged with the substrate 26 shown in FIG. 3A. In other words, the display 30 shown in FIG. 3B may act as the substrate 26 upon which the circular polarizer 32 is disposed. The display 30 shown in FIG. 3B may be an emissive display, such as an Organic Light Emitting Display (OLED) or an Inorganic Light Emitting Display or a Quantum Dot Light Emitting Display. The use of the circular polarizer 32 disposed on the viewing side 20 of an emissive display, especially an OLED, is well known to reduce ambient reflections from the emissive display and therefore improve image quality.

FIG. 3C shows an alternative display device 22 that is comprised from the viewing side 20 of a circular polarizer 32, a substrate 26, an adhesive layer 34 and a display 30. To create the display device 22 as shown in FIG. 3C, the optical element 24 of FIG. 3A has been adhered to the display 30 using the adhesive layer 34.

FIG. 3D shows a circular polarizer 32 that may be used in conjunction with any of the preceding or proceeding implementations. The circular polarizer 32 is comprised of a reactive mesogen (RM) quarter wave plate (QWP) alignment layer 36 configured to align an optical axis of an RM layer at an in-plane angle of ϕ=n+45° (where n is a real number), an RM QWP layer 38 with an optical axis aligned at in-plane angle of ϕ=n+45°, a lyotropic (chromonic) LC polarizer alignment layer 40 configured to align the transmission axis of a lyotropic LC polarizer at an in-plane angle of ϕ=n+0°, and, a lyotropic LC polarizer layer 42 (containing the lyotropic LC polarizer) with the transmission axis aligned at in-plane angle of ϕ=n+0°. Each layer (26, 30, 32, 34) within the circular polarizer 32 may be deposited used a standard deposition process. Standard deposition processes include spin coating, ink-jet printing, slot-die coating, dip coating, spray coating, etc., or any combination thereof.

Still referring to FIG. 3D, lyotropic LC polarizer materials pertaining to the implementations described herein are typically comprised of dichroic dye molecules that are dissolved in a solvent (typically water). The solution of dichroic dye and water form a lyotropic LC phase. Other chemicals, such as surfactants, may also be dissolved in the lyotropic LC polarizer solution. When the lyotropic LC polarizer solution (e.g., water+dichroic dye) is deposited on a surface (such as a substrate or an alignment layer, etc.), the water evaporates, leaving the dichroic dye molecules. If the dichroic dye molecules have uniform alignment, then the dichroic dye will operate as a linear polarizer. To align the dichroic dye molecules in a preferred direction, a combination of an alignment layer and/or deposition technique may be used.

FIG. 3E shows a linear polarizer 44 that may be used in conjunction with any of the preceding or proceeding embodiments. The linear polarizer 44 is comprised of a lyotropic LC polarizer alignment layer 40 configured to align the transmission axis of a lyotropic LC polarizer at an in-plane angle of ϕ=n+0°, and a lyotropic LC polarizer layer 42 with the transmission axis aligned at in-plane angle of ϕ=n+0°.

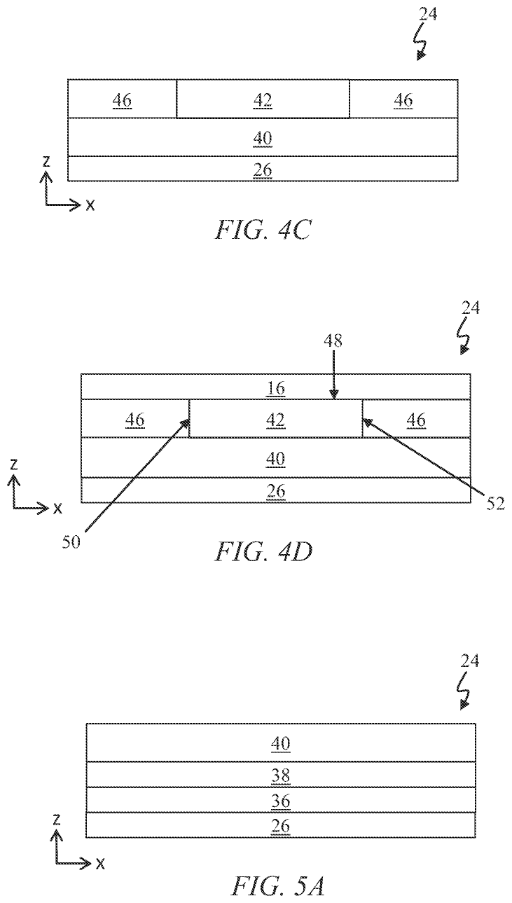

FIGS. 4A through 4D show consecutive manufacturing steps used to create an optical element that may be used in conjunction with any of the preceding or proceeding embodiments. The optical element 24 shown in FIG. 4D is a linear polarizer.

FIG. 4A shows a substrate 26 upon which a lyotropic LC polarizer alignment layer 40 has been deposited. At this stage, the lyotropic LC polarizer alignment layer 40 may be configured to align the transmission axis of a lyotropic LC polarizer (e.g., lyotropic LC polarizer layer 42 of FIGS. 4C-4D) at an in-plane angle of ϕ=n+0° where n is a real number. The alignment direction of the lyotropic LC polarizer alignment layer 40 may be configured using a rubbing process, a photoalignment process, a plasma treatment process, an ultra-violet light treatment process, an ozone treatment process, or any combination thereof.

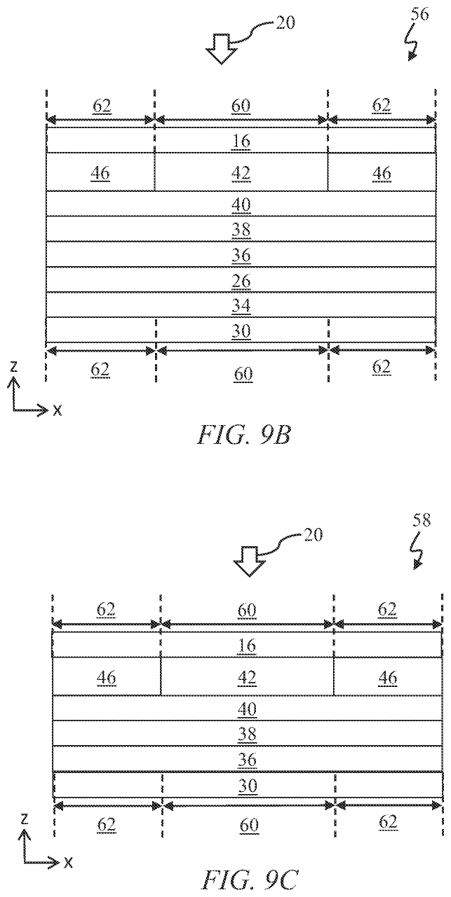

FIG. 4B shows a patterned hydrophobic layer 46 that has been deposited upon the optical element 24 shown in FIG. 4A. The patterned hydrophobic layer 46 is patterned such that the patterned hydrophobic layer 46 is located outside of the viewing area 60 (FIG. 9A) (i.e., outside of the active area) of a display device 56/58 (FIG. 9A). The viewing area 60 (i.e., the active area) is the area of the display device 56/58 that contains pixels whereas a non-viewing area 62 (FIG. 9A) of the display device 56/58 does not contain pixels.

Still referring to FIG. 4B, the patterned hydrophobic layer 46 may be a liquid crystal alignment layer that promotes vertical alignment (VA) of liquid crystals. The VA layer may be a type of polyimide material. Alternatively, the patterned hydrophobic layer 46 may be a type of fluoropolymer, such as polytetrafluoroethylene (PTFE), polyvinylfluoride, polyvinylidene fluoride, polychlorotrifluoroethylene, perfluoroalkoxy polymer, fluorinated ethylene-propylene, polyethylenetetrafluoroethylene, polyethylenechlorotrifluoroethylene, Perfluorinated Elastomer, Fluorocarbon, Chlorotrifluoroethylenevinylidene fluoride, Fluoroelastomer, Tetrafluoroethylene-Propylene and Perfluoropolyether. Commercial examples of hydrophobic fluoropolymers include, but are not limited to, TEFLON® and CYTOP®. For aesthetic purposes, the patterned hydrophobic layer 46 may be colorless, colored, or black.

The patterned hydrophobic layer 46 is deposited using a deposition technique that is capable of directly patterning the patterned hydrophobic layer 46. For example, the patterned hydrophobic layer 46 may be deposited using ink-jet printing. After the patterned hydrophobic layer 46 has been deposited, the alignment direction of the lyotropic LC polarizer alignment layer 40 may be configured (or further configured) using a rubbing process, a photoalignment process, a plasma treatment process, an ultra-violet light treatment process, an ozone treatment process, or any combination thereof.

FIG. 4C shows a lyotropic LC polarizer layer 42 deposited onto the lyotropic LC polarizer alignment layer 40. The lyotropic LC polarizer layer 42 may be deposited using a deposition technique that is not capable of directly patterning the lyotropic LC polarizer layer 42. For example, the lyotropic LC polarizer layer 42 may be deposited via spin coating, slot-die coating, dip coating, spray coating, etc., or any combination thereof. The presence of the patterned hydrophobic layer 46 effectively patterns the lyotropic LC polarizer layer 42 since the water content of the lyotropic LC polarizer solution is repelled by the patterned hydrophobic layer 46. In other words, a lyotropic LC polarizer solution, consisting mainly of water and dichroic dye, does not adhere to the patterned hydrophobic layer 46. Consequently, when the water evaporates from the deposited lyotropic LC polarizer solution, the lyotropic LC polarizer layer 42 may be comprised of uniformly aligned dichroic dye molecules that have been spatially patterned according to the patterning of the patterned hydrophobic layer 46.

The lyotropic LC polarizer layer 42 may be thinner in the z-direction than the patterned hydrophobic layer 46 (although, as illustrated in FIG. 4C, they are the same thickness in the z-direction). The lyotropic LC polarizer layer 42 may be the same thickness in the z-direction as the patterned hydrophobic layer 46, as illustrated in FIG. 4C. The lyotropic LC polarizer layer 42 may be thicker than the patterned hydrophobic layer 46 (although, as illustrated in FIG. 4C, they are the same thickness in the z-direction).

A first surface of the lyotropic LC polarizer layer 42 may be in the same x-y plane as a first surface of the patterned hydrophobic layer 46. A first and second surface of the lyotropic LC polarizer layer 42 may be in the same x-y planes as a first and second surface of the patterned hydrophobic layer 46. At least one surface of the lyotropic LC polarizer layer 42 may be in the same x-y plane as at least one surface of the patterned hydrophobic layer 46. After the patterned hydrophobic layer 46 has been deposited, the exposed surface (i.e., non-substrate side) of the optical element 24 may have a surface energy modification treatment that may include a plasma treatment process, an ultra-violet light treatment process, an ozone treatment process, or any combination thereof.

After the lyotropic LC polarizer layer 42 has been deposited, the exposed surface (i.e., non-substrate side) of the optical element 24 may have a surface energy modification treatment that may include a plasma treatment process, an ultra-violet light treatment process, an ozone treatment process, or any combination thereof. The purpose of the surface energy modification process is to enable an overcoat layer 16 (FIG. 4D) to adhere to the patterned hydrophobic layer 46 and/or the lyotropic LC polarizer layer 42.

FIG. 4D shows deposition of an overcoat layer 16 to protect the lyotropic LC polarizer layer 42 from mechanical and/or chemical damage. The overcoat layer 16 protects the top of the lyotropic LC polarizer layer 42 (see top protection 48 as shown in FIG. 4D). The overcoat layer 16 and/or the patterned hydrophobic layer 46 protect the sides of the lyotropic LC polarizer layer 42 (see first side protection 50 and second side protection 52 as shown in FIG. 4D). Although FIG. 4D shows only the patterned hydrophobic layer 46 protecting the lyotropic LC polarizer layer 42 on its sides (i.e., at the first side protection 50 and the second side protection 52), it will be appreciated that this is merely a limitation of the diagram. The relative thickness in the z-direction of the patterned hydrophobic layer 46 and the lyotropic LC polarizer layer 42 will determine the proportion of side protection provided by patterned hydrophobic layer 46 and the overcoat layer 16.

For example, if the patterned hydrophobic layer 46 is thicker than the lyotropic LC layer polarizer layer 42, then the patterned hydrophobic layer 46 may perform all of the side protection function. However, if the patterned hydrophobic layer 46 is thinner than the lyotropic LC layer polarizer layer 42, then the overcoat layer 16 will provide at least some of the side protection function. If the thickness of the patterned hydrophobic layer 46 is negligible compared to the thickness of the lyotropic LC layer polarizer layer 42, then the overcoat layer 16 will effectively provide all of the side protection function. In general, all sides of the lyotropic LC layer polarizer layer 42 are protected by the patterned hydrophobic layer 46 and/or the overcoat layer 16.

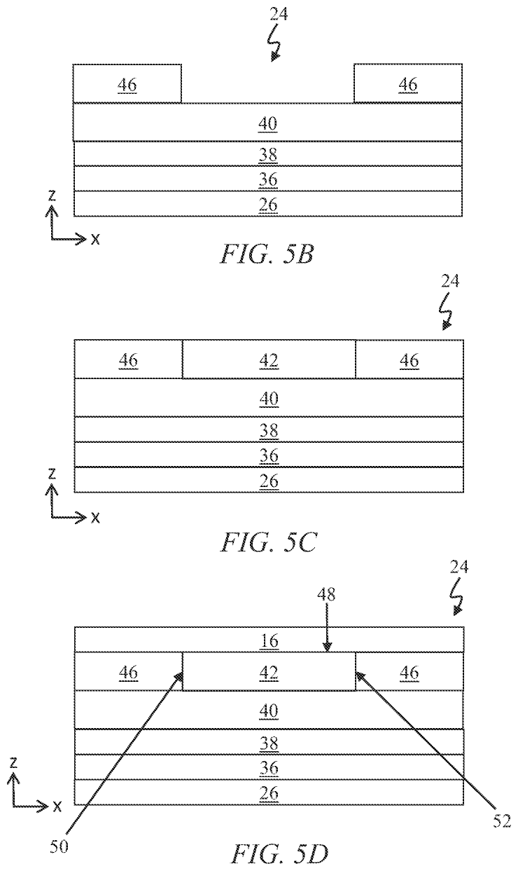

FIGS. 5A through 5D show consecutive manufacturing steps used to create an optical element 24 that may be used in conjunction with any of the preceding or proceeding implementations. The optical element 24 shown in FIG. 5D may be a circular polarizer.

Referring to FIG. 5A, in a first step an RM QWP alignment layer 36 is deposited on a substrate 26. The RM QWP alignment layer 36 is configured to align an optical axis of an RM QWP layer 38 at an in-plane angle of ϕ=n+45° (where n is a real number). The alignment direction of the RM QWP alignment layer 36 may be configured using a conventional rubbing process or a conventional photoalignment process. In a second step, an RM QWP layer 38 with an optical axis aligned at an in-plane angle of ϕ=n+45° is deposited on the RM QWP alignment layer 36. In a third step, a lyotropic LC polarizer alignment layer 40 is deposited on the RM QWP layer 38. The lyotropic LC polarizer alignment layer 40 is configured to align an optical axis of a lyotropic LC polarizer layer 42 at an in-plane angle of ϕ=n+0° (where n is a real number). The alignment direction of the lyotropic LC polarizer alignment layer 40 may be configured using a rubbing process, a photoalignment process, a plasma treatment process, an ultra-violet light treatment process, an ozone treatment process, or any combination thereof.

The subsequent fabrication steps shown in FIGS. 5B through 5D are identical to the corresponding fabrication steps as shown in FIGS. 4B through 4D, respectively.

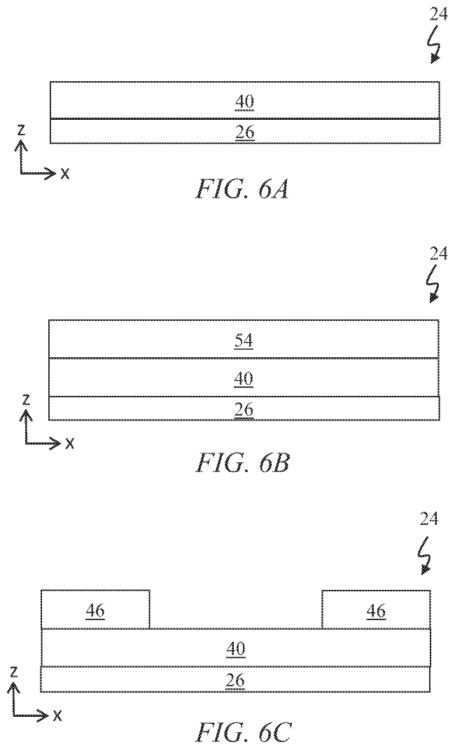

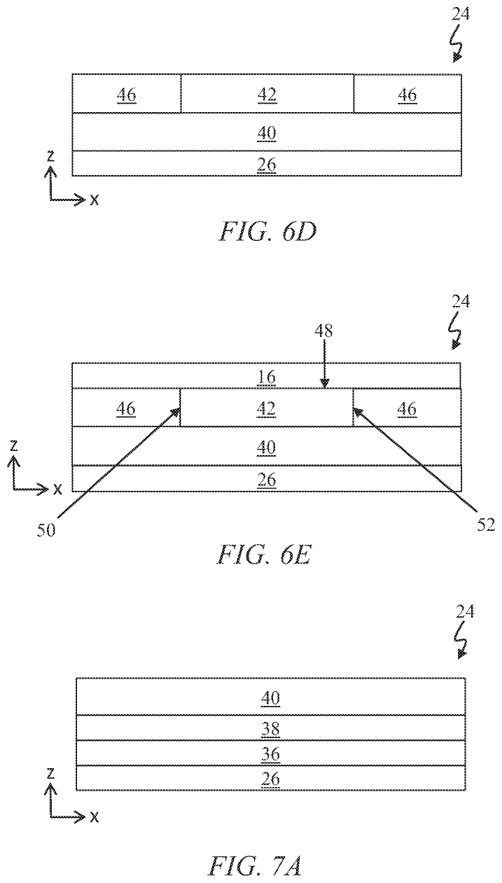

FIGS. 6A through 6E show consecutive manufacturing steps used to create an optical element that may be used in conjunction with any of the preceding or proceeding implementations. The optical element shown in FIG. 6E may be a linear polarizer.

FIG. 6A shows a substrate 26 upon which a lyotropic LC polarizer alignment layer 40 has been deposited. At this stage, the lyotropic LC polarizer alignment layer 40 may be configured to align the transmission axis of a lyotropic LC polarizer layer 42 at an in-plane angle of ϕ=n+0°. The alignment direction of the lyotropic LC polarizer alignment layer 40 may be configured using a rubbing process and/or a photoalignment process and/or a plasma treatment process and/or an ultra-violet treatment process and/or an ozone treatment process. FIG. 6A is essentially identical to FIG. 4A.

FIG. 6B shows an unpatterned hydrophobic layer 54 that has been deposited upon the optical element shown in FIG. 6A. The unpatterned hydrophobic layer 54 may be a liquid crystal alignment layer that promotes vertical alignment (VA) of liquid crystals. The unpatterned hydrophobic layer 54 in such an instance may be a type of polyimide material. Alternatively, the unpatterned hydrophobic layer 54 may be a type of fluoropolymer, such as polytetrafluoroethylene (PTFE), polyvinylfluoride, polyvinylidene fluoride, polychlorotrifluoroethylene, perfluoroalkoxy polymer, fluorinated ethylene-propylene, polyethylenetetrafluoroethylene, polyethylenechlorotrifluoroethylene, perfluorinated elastomer, fluorocarbon, chlorotrifluoroethylenevinylidene fluoride, fluoroelastomer, tetrafluoroethylene-propylene and perfluoropolyether. For aesthetic purposes, the unpatterned hydrophobic layer 54 may be colorless, colored or black.

Commercial examples of hydrophobic fluoropolymers include, but are not limited to, TEFLON® and CYTOP®. The unpatterned hydrophobic layer 54 may be deposited using a deposition technique that is not capable of directly patterning the unpatterned hydrophobic layer 54, for example, the unpatterned hydrophobic layer 54 may be deposited via spin coating, slot-die coating, dip coating, spray coating etc. or any combination thereof.

FIG. 6C shows the result of a patterning process has been used to pattern the unpatterned hydrophobic layer 54 (FIG. 6B), resulting in patterned hydrophobic layer 46. The patterned hydrophobic layer 46 is patterned such that the patterned hydrophobic layer 46 is located outside of the viewing area 60 (FIG. 9A) (i.e., outside of an active area) of a display device 56/58 (FIG. 9A). The viewing area 60 (i.e., the active area) is the area of the display device 56/58 (FIG. 9A) that contains pixels whereas a non-viewing area 62 (FIG. 9A) of the display device 56/58 does not contain pixels. The patterning process may use a conventional photoresist and conventional photolithographic equipment. If a photoresist is used to pattern the patterned hydrophobic layer 46, the photoresist is patterned by conventional means and the exposed unpatterned hydrophobic layer 54 (FIG. 6B) is selectively etched using either a wet etch process or a dry etch process.

Alternatively, the patterning process may use a shadow mask and a dry etch process. The dry etch processes disclosed above may use a reactive ion beam etch, plasma etch, UV etch or any combination thereof to remove exposed portions of the unpatterned hydrophobic layer 54 (FIG. 6B). The wet etch process disclosed above may use an acid, alkali, or solvent to remove exposed portions of the unpatterned hydrophobic layer 54. After the patterned hydrophobic layer 46 has been patterned, the exposed surface of the optical element 24 may have a surface energy modification treatment that may include a plasma treatment process, an ultra-violet treatment process, an ozone treatment process, or any combination thereof. The purpose of the surface energy modification process is to enable an overcoat layer 16 (see, e.g., FIG. 4D) to adhere to the patterned hydrophobic layer 46 and/or the lyotropic LC polarizer layer 42.

The subsequent fabrication steps shown in FIGS. 6D through 6E are identical to the corresponding fabrication steps shown in FIGS. 4C through 4D, respectively.

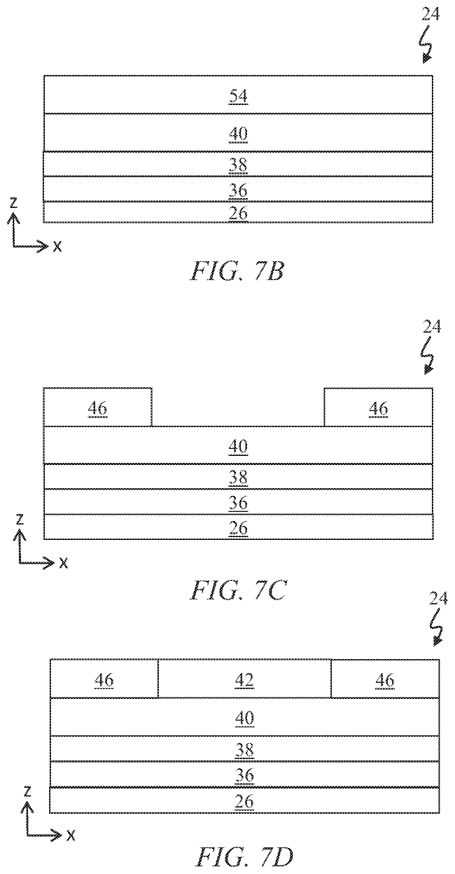

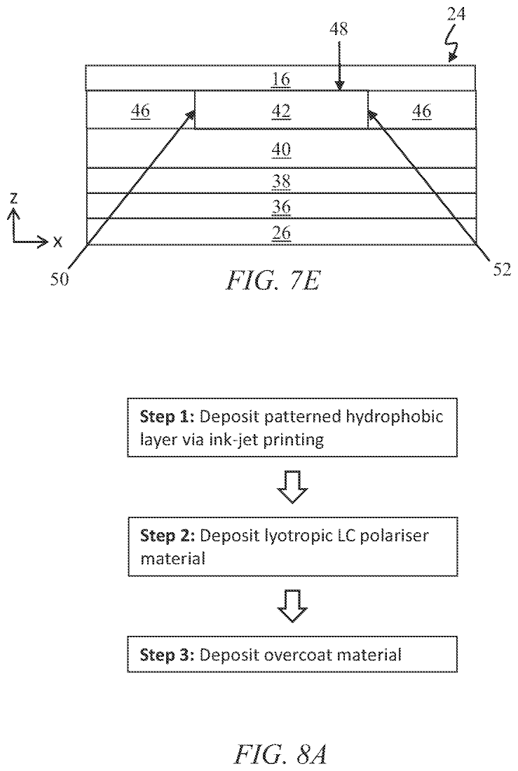

FIGS. 7A through 7E show consecutive manufacturing steps used to create an optical element 24 that may be used in conjunction with any of the preceding or proceeding implementations. The optical element 24 shown in FIG. 7E may be a circular polarizer.

Referring to FIG. 7A, in a first step an RM QWP alignment layer 36 is deposited on a substrate 26. The RM QWP alignment layer 36 is configured to align an optical axis of an RM layer at an in-plane angle of ϕ=n+45° (where n is a real number). The alignment direction of the RM QWP alignment layer 36 may be configured using a conventional rubbing process or a conventional photoalignment process. In a second step, an RM QWP layer 38 with an optical axis aligned at in-plane angle of ϕ=n+45° is deposited on top of the RM QWP alignment layer 36. In a third step, a lyotropic LC polarizer alignment layer 40 is deposited on the RM QWP layer 38. The lyotropic LC polarizer alignment layer 40 is configured to align an optical axis of a lyotropic LC polarizer layer 42 (FIGS. 7D, 7E) at an in-plane angle of ϕ=n+0° (where n is a real number).

The alignment direction of the lyotropic LC polarizer alignment layer 40 may be configured using a rubbing process, a photoalignment process, a plasma treatment process, an ultra-violet light treatment process, an ozone treatment process, or any combination thereof. The subsequent fabrication steps shown in FIGS. 7B through 7E are identical to the corresponding fabrication steps shown in FIGS. 6B through 6E, respectively.

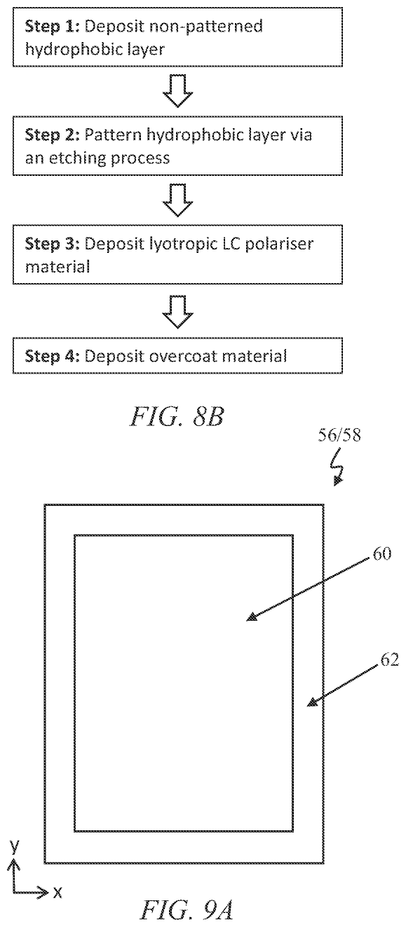

FIGS. 8A and 8B illustrate in flowchart form summaries of the inventive steps disclosed by the aforementioned implementations described in this document. FIG. 8A illustrates a flowchart summarizing inventive steps described by FIG. 4B through 4D. The flowchart shown in FIG. 8A also summarizes inventive steps described by FIG. 5B through 5D. FIG. 8B illustrates a flowchart summarizing inventive steps described by FIG. 6B through 6E. The flowchart shown in FIG. 8B also summarizes inventive steps described by FIG. 7B through 7E.

FIG. 9A shows a plan view (i.e., in the x-y plane) of a first alternative implementation display device 56, and a second alternative implementation display device 58, as shown in side view in FIGS. 9B and 9C, respectively. Both the first alternative implementation display device 56 and the second alternative implementation display device 58 typically include a viewing area 60 (also known as an “active area”) and a non-viewing area 62. The viewing area 60 (i.e., “active area”) is the area of the display device 56/58 containing pixels, whereas the non-viewing area 62 of the display device 56/58 does not contain pixels. Consequently, the viewing area 60 displays an image whereas the non-viewing area 62 does not display an image. The non-viewing area 62 at least partially surrounds the viewing area 60.

FIG. 9B shows a side view (i.e., in the x-z plane) of the first alternative implementation display device 56. The first alternative implementation display device 56 shown in FIG. 9B may be an emissive display, such as an Organic Light Emitting Display (OLED) or an Inorganic Light Emitting Display or a Quantum Dot Light Emitting Display. The first alternative implementation display device 56 includes a viewing area 60 and a non-viewing area 62, as shown in FIG. 9A. In the illustrated implementation, the patterned hydrophobic layer 46 is patterned so that it is not present in the viewing area 60. The patterned hydrophobic layer 46 is patterned so that it is entirely contained within the non-viewing area 62. The patterned hydrophobic layer 46 at least partially covers the non-viewing area 62.

FIG. 9C shows a side view (i.e., in the x-z plane) of the second alternative implementation display device 58. The second alternative implementation display device 58 shown in FIG. 9C may be an emissive display, such as an Organic Light Emitting Display (OLED) or an Inorganic Light Emitting Display or a Quantum Dot Light Emitting Display. The second alternative implementation display device 58 also includes a viewing area 60 and a non-viewing area 62 as shown in FIG. 9A. In the illustrated implementation, the patterned hydrophobic layer 46 is patterned so that it is not present in the viewing area 60. The patterned hydrophobic layer 46 is patterned so that it is entirely contained within the non-viewing area 62. The patterned hydrophobic layer 46 at least partially covers the non-viewing area 62.

A possible advantage of the first alternative implementation display device 56 over the second alternative implementation display device 58 is that the first alternative implementation display device 56 may be easier to manufacture than the second alternative implementation display device 58; therefore, the first alternative implementation display device 56 may enable a higher mass production yield. A potential advantage of the second alternative implementation display device 58 over the first alternative implementation display device 56 is that second alternative implementation display device 58 is thinner than the first alternative implementation display device 56, and therefore the second alternative implementation display device 58 may be of lighter weight and easier to fold.

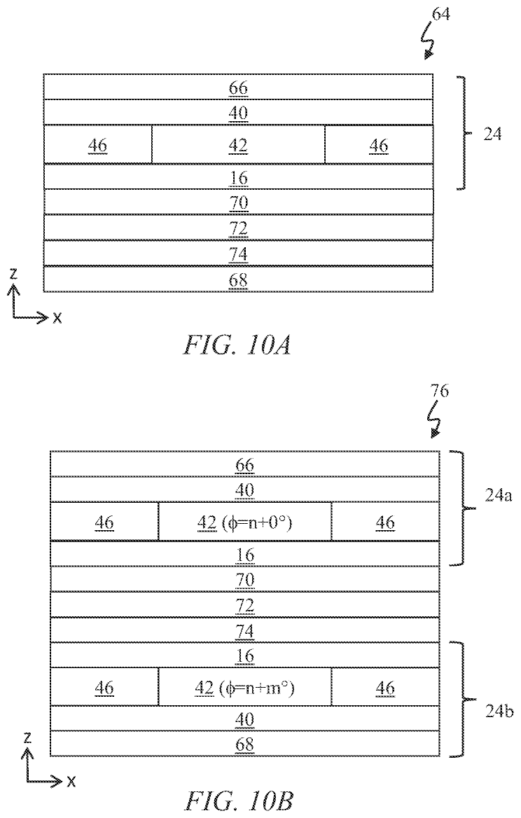

FIG. 10A shows part of a first alternative implementation liquid crystal display (LCD) 64 that includes a first optical element 24 as shown in FIG. 4D. For reasons of clarity and simplicity, many essential elements for the correct operation of the first alternative implementation LCD 64, such as additional polarizer(s), a TFT array, colour filter array, a backlight, etc., are omitted from the illustrated view. Either the first substrate 66 or the second substrate 68 may be disposed on the viewing side of the first alternative implementation LCD 64. The first alternative implementation LCD 64 shown in FIG. 10A contains an “in-cell polarizer” since the lyotropic LC polarizer layer 42 is disposed between the first substrate 66 and the second substrate 68 that comprise the first alternative implementation LCD 64 (along with a first liquid crystal alignment layer 70, a liquid crystal layer 72, and a second liquid crystal alignment layer 74). The in-cell polarizer may be used to improve the contrast ratio of the first alternative implementation LCD 64.

FIG. 10B shows part of a second alternative implementation LCD 76 that includes a first optical element 24a as shown in FIG. 4D, and a second optical element 24b, also as shown in FIG. 4D. For reasons of clarity and simplicity, many essential elements for the correct operation of the second alternative implementation LCD 76, such as additional polarizer(s), a TFT array, colour filter array, a backlight, etc., are missing from the illustrated view. The second alternative implementation LCD 76 shown in FIG. 10B contains an “in-cell polarizer” since the lyotropic LC polarizer layers 42 of the first optical element 24a and the second optical element 24b are disposed between the first substrate 66 and the second substrate 68 that comprise the second alternative implementation LCD 76. The in-cell polarizers may be used to improve the contrast ratio of the second alternative implementation LCD 76.

Referring to the lyotropic LC polarizer layer 42 of the first optical element 24a and the second optical element 24b, the alignment direction defined by the azimuth angle ϕ=n+m° is configured such that n is a real number and m is either 0° or 90° depending upon the LC mode. For example, if the LC mode is a normally black TN LCD, m=0° (i.e., the transmission axes of the in-cell lyotropic LC polarizer layers 42 are aligned parallel). However, if the LC mode is a normally white TN LCD, or a normally black IPS LCD or a normally black FFS LCD, then m=90° (i.e., the transmission axes of the in-cell lyotropic LC polarizer layers 42 are aligned perpendicular).

From the present disclosure, various techniques may be used for implementing the concepts described in the present disclosure without departing from the scope of those concepts. While the concepts have been described with specific reference to certain implementations, a person of ordinary skill in the art may recognize that changes may be made in form and detail without departing from the scope of those concepts. As such, the described implementations are to be considered in all respects as illustrative and not restrictive. It should also be understood that the present disclosure is not limited to the implementations described, but rather many rearrangements, modifications, and substitutions are possible without departing from the scope of the present disclosure.

What is claimed is:

1. A liquid crystal (LC) polarizer for use with a display device having a viewing area and a non-viewing area, the LC polarizer comprising:
a patterned hydrophobic layer; and
a patterned lyotropic LC polarizer layer, wherein:
the patterned hydrophobic layer surrounds the patterned lyotropic LC polarizer layer; and
the patterned hydrophobic layer is wholly contained within the non-viewing area of the display device.

2. The LC polarizer of claim 1, wherein the patterned lyotropic LC polarizer layer is formed from an evaporated lyotropic LC polarizer solution of water and dichroic dye.

3. The LC polarizer of claim 1, wherein the patterned lyotropic LC polarizer layer comprises substantially uniformly aligned dichroic dye molecules, the dichroic dye molecules spatially patterned according to a patterning of the patterned hydrophobic layer.

4. The LC polarizer of claim 1, wherein the patterned lyotropic LC polarizer layer has a thickness different from a thickness of the patterned hydrophobic layer.

5. The LC polarizer of claim 1, further comprising a lyotropic LC polarizer alignment layer adjacent to the patterned lyotropic LC polarizer layer.

6. The LC polarizer of claim 5, wherein the lyotropic LC polarizer alignment layer is configured to align a transmission axis of the patterned lyotropic LC polarizer layer at a first in-plane angle relative to the display device.

7. The LC polarizer of claim 5, wherein an alignment direction of the lyotropic LC polarizer alignment layer is configured using at least one of a rubbing process, a photoalignment process, a plasma treatment process, an ultra-violet light treatment process, and an ozone treatment process.

8. The LC polarizer of claim 5, further comprising a substrate adjacent the lyotropic LC polarizer alignment layer.

9. The LC polarizer of claim 1, further comprising a reactive mesogen (RM) quarter wave plate (QWP) layer.

10. The LC polarizer of claim 9, further comprising an RM QWP alignment layer adjacent the RM QWP layer.

11. The LC polarizer of claim 10, wherein the RM QWP alignment layer is configured to align a transmission axis of the RM QWP layer at a second in-plane angle relative to the display device.

12. The LC polarizer of claim 11, wherein the second in-plane angle is 45° relative to a first in-plane angle of the patterned lyotropic LC polarizer layer.

13. The LC polarizer of claim 10, further comprising a substrate adjacent the RM QWP alignment layer.

14. The LC polarizer of claim 1, further comprising an overcoat layer, the overcoat layer configured to extend over the patterned lyotropic LC polarizer layer, and the patterned hydrophobic layer.

15. The LC polarizer of claim 14, wherein at least one of the patterned hydrophobic layer and the patterned lyotropic LC polarizer layer is configured with a modified surface energy that facilitates adhering the overcoat layer thereto.

16. The LC polarizer of claim 1, wherein the patterned hydrophobic layer comprises a fluoropolymer material including at least one of a material selected from the group consisting of polytetrafluoroethylene (PTFE), polyvinylfluoride, polyvinylidene fluoride, polychlorotrifluoroethylene, perfluoroalkoxy polymer, fluorinated ethylene-propylene, polyethylenetetrafluoroethylene, polyethylenechlorotrifluoroethylene, Perfluorinated Elastomer, Fluorocarbon, Chlorotrifluoroethylenevinylidene fluoride, Fluoroelastomer, Tetrafluoroethylene-Propylene, Perfluoropolyether, polyimide, and a liquid crystal alignment layer that promotes vertical alignment of liquid crystals.

17. The LC polarizer of claim 1, wherein the viewing area contains pixels of the display device, and the non-viewing area lacks pixels of the display device.

18. The LC polarizer of claim 1, further comprising a liquid crystal display, wherein the LC polarizer is an in-cell polarizer.

19. A polarizer for use with a display device having a viewing area and a non-viewing area, the polarizer comprising:
a patterned hydrophobic layer;
a patterned lyotropic liquid crystal (LC) polarizer layer;
a lyotropic LC polarizer alignment layer;
a reactive mesogen (RM) quarter wave plate (QWP) layer; and
an RM QWP alignment layer, wherein:
the patterned hydrophobic layer surrounds the patterned lyotropic LC polarizer layer;
the patterned hydrophobic layer is wholly contained within the non-viewing area of the display device; and
the RM QWP alignment layer is adjacent the display device.

20. A polarizer for use with a display device having a viewing area and a non-viewing area, the polarizer comprising:
a patterned hydrophobic layer;
a patterned lyotropic liquid crystal (LC) polarizer layer;
a lyotropic LC polarizer alignment layer;
a reactive mesogen (RM) quarter wave plate (QWP) layer;
an RM QWP alignment layer;
a substrate; and
an adhesive, wherein:
the patterned hydrophobic layer surrounds the patterned lyotropic LC polarizer layer;
the patterned hydrophobic layer is wholly contained within the non-viewing area of the display device;
the substrate is adjacent to the RM QWP alignment layer; and
the adhesive is disposed between the substrate and the display device.
